(19) United States
(12) Patent Application Publication
(10) Pub. No.: US 2016/0203503 A1
(43) Pub. Date: Jul. 14, 2016

(54) SYSTEM FOR COLLECTING AFFILIATE STORE LOCATION INFORMATION USING MEMBERSHIP CARD USE INFORMATION, METHOD OF COLLECTING AFFILIATE STORE LOCATION INFORMATION, AND APPARATUS FOR THE SAME

(71) Applicant: SK PLANET CO., LTD., Seongnam-si (KR)

(72) Inventors: Ho-Seok LEE, Seoul (KR); Eun-Su JEONG, Gwacheon-si Gyeonggi-do (KR)

(21) Appl. No.: 14/957,343

(22) Filed: Dec. 2, 2015

(30) Foreign Application Priority Data
Jan. 13, 2015 (KR) 10-2015-0006051

(51) Int. Cl. G06Q 30/02

(52) U.S. Cl. CPC G06Q 30/0205

(57) ABSTRACT

Disclosed herein are a system for collecting affiliate store location information using information about use of a membership card, a method for collecting affiliate store location information, and a device for the method. The device for collecting affiliate store location information receives usage log information about a membership card, used through an application, from a terminal device, stores the usage log information in connection with an affiliate store in which the membership card was used, and may register the location of the affiliate store in an affiliate store database depending on whether the collected usage log information meets a predetermined registration condition, in order to provide the terminal device with an affiliate store location service. Because the affiliate store location information is provided using the location information acquired from users using the membership card, more accurate and up-to-date affiliate store location information may be provided.

### CROSS REFERENCE TO RELATED APPLICATION

This application claims the benefit of Korean Patent Application No. 10-2015-0006051, filed Jan. 13, 2015, which is hereby incorporated by reference in its entirety into this application.

### BACKGROUND OF THE INVENTION

1. Technical Field

The present invention generally relates to a method for collecting information about the locations of affiliate stores. More particularly, the present invention relates to a system for collecting affiliate store location information using information about the use of membership cards, a method for collecting affiliate store location information, and an apparatus for the method, which register the location of an affiliate store using information, collected when users use membership cards in the affiliate store, whereby information about the locations of affiliate stores may be collected while saving manpower and time.

2. Description of the Related Art

“Location information” refers to information about the place where a portable object or individual exists or existed at a certain time, collected by means of telecommunication equipment and telecommunication line equipment pursuant to the provisions in Article 2 of Korean law on the protection and use of location information. Also, “location information” may mean a location-based service associated with the collection, provision and use of information about the location of an object or individual.

Such location information may be used in various fields. Recently, a service for providing mobile terminal users with information about the locations of various membership affiliate stores is actively being developed. However, when the locations of affiliate stores over a wide area are provided, because a relevant affiliate store has closed and another store has opened or because information about a newly opened affiliate store is not updated, inaccurate information may occasionally be provided. Also, according to the conventional method for checking the locations of affiliate stores, because people have to travel around to search for the locations of affiliate stores and collect the location of every single affiliate store, a large amount of manpower and time is required.

Therefore, in order to provide users with the latest accurate locations of affiliate stores, a new technique for collecting affiliate store location information, capable of registering affiliate store information based on information collected when users use membership cards in the affiliate stores, is required.

### SUMMARY OF THE INVENTION

An object of the present invention is to provide users with reliable information about the locations of affiliate stores by acquiring the locations of the affiliate stores by collecting information about use of membership cards by users in the real world.

Another object of the present invention is to save manpower, time, and cost required for collecting information about the locations of affiliate stores.

In order to accomplish the above object, a device for collecting affiliate store location information according to the present invention includes a usage log reception unit for receiving usage log information about a membership card, used through an application, from a terminal device; a usage log storage unit for storing the usage log information in connection with an affiliate store in which the membership card was used; and an affiliate store registration unit for determining whether the usage log information has been collected so as to meet a predetermined registration condition, and for registering a location of the affiliate store in which the membership card was used in an affiliate store database to provide an affiliate store location service to the terminal device when the usage log information has been collected so as to meet the predetermined registration condition.

The predetermined registration condition may correspond to at least one of a case in which the usage log information has been collected for a time period equal to or longer than a predetermined reference collection period and a case in which a number of the collected pieces of usage log information is equal to or greater than a predetermined reference collection number.

The usage log information may correspond to at least one of card identification information corresponding to the membership card, information about a current location of the terminal device, and information about a Wi-Fi access point of the affiliate store in which the membership card was used.

The affiliate store registration unit may be configured to search for one or more pieces of card identification information for each affiliate store in which the membership card was used using the information about the Wi-Fi access point, and to register a location of the affiliate store corresponding to the one or more pieces of card identification information depending on a determination of whether, among the one or more pieces of card identification information, a number of identical pieces of card identification information that have been collected is equal to or greater than the predetermined reference collection number.

The affiliate store registration unit may store the usage log information corresponding to the identical pieces of card identification information in the affiliate store database, and register the information about the current location of the terminal device, received along with the identical pieces of card identification information from the terminal device, as the location of the affiliate store in which the membership card was used.

The device for collecting affiliate store location information may further include an affiliation store location provision unit for searching the affiliate store database for one or more affiliate stores in which the membership card is capable of being used based on the usage log information, and for performing the affiliate store location service by providing locations of the found one or more affiliate stores to the terminal device.

The affiliate store location provision unit may search the affiliate store database for one or more pieces of Wi-Fi access point information corresponding to the card identification information, and provide the locations of the one or more affiliate stores using information about a current location of the terminal device corresponding to the one or more pieces of Wi-Fi access point information.

The affiliate store registration unit may compare membership points before the membership card was used with membership points after the membership card was used, and may not register a location of the affiliate store in which the membership card was used if the membership points before the membership card was used are identical to the membership points after the membership card was used.

Also, a terminal device according to the present invention includes: a usage log collection unit for collecting usage log information about one or more of card identification information about a membership card used through an application, current location information, and information about a Wi-Fi access point of an affiliate store in which the membership card was used; a usage log transmission unit for transmitting the usage log information to an affiliate store location information collection device to enable the affiliate store location information collection device to provide an affiliate store location service for showing, based on the usage log information, locations of one or more affiliate stores in which the membership card is capable of being used; and a service provision unit for providing the affiliate store location service to a user by receiving the locations of the one or more affiliate stores from the affiliate store location information collection device.

The usage log collection unit may collect the usage log information using at least one of the application and one or more types of sensors included in the terminal device.

The service provision unit may display the locations of the one or more affiliate stores on a map.

Also, a method for collecting affiliate store location information using information about use of a membership card, according to the present invention, includes: receiving usage log information about the membership card, used through an application, from a terminal device; storing the usage log information in connection with an affiliate store in which the membership card was used; determining whether the usage log information has been collected so as to meet a predetermined registration condition; and registering a location of the affiliate store in which the membership card was used in an affiliate store database to provide an affiliate store location service to the terminal device when the usage log information has been collected so as to meet the predetermined registration condition.

The predetermined registration condition may correspond to at least one of a case in which the usage log information has been collected for a time period equal to or longer than a predetermined reference collection period and a case in which a number of the collected pieces of usage log information is equal to or greater than a predetermined reference collection number.

The usage log information may correspond to at least one of card identification information corresponding to the membership card, information about a current location of the terminal device, and information about a Wi-Fi access point of the affiliate store in which the membership card was used.

Registering the location of the affiliate store comprises searching for one or more pieces of card identification information for each affiliate store in which the membership card was used using the information about the Wi-Fi access point, and a location of the affiliate store corresponding to the one or more pieces of card identification information may be registered depending on a determination of whether, among the one or more pieces of card identification information, a number of identical pieces of card identification information that have been collected is equal to or greater than the predetermined reference collection number.

Registering the location of the affiliate store further includes storing the usage log information corresponding to the identical pieces of card identification information in the affiliate store database, and the information about the current location of the terminal device, received along with the identical pieces of card identification information from the terminal device, may be registered as the location of the affiliate store in which the membership card was used.

The method for collecting affiliate store location information may further include searching the affiliate store database for one or more affiliate stores in which the membership card is capable of being used based on the usage log information, and performing the affiliate store location service by providing locations of the found one or more affiliate stores to the terminal device.

Also, a method for collecting affiliate store location information using information about use of a membership card, according to the present invention includes: collecting usage log information about one or more of card identification information about a membership card used through an application, current location information, and information about a Wi-Fi access point of an affiliate store in which the membership card was used; transmitting the usage log information to an affiliate store location information collection device to enable the affiliate store location information collection device to provide an affiliate store location service for showing, based on the usage log information, locations of one or more affiliate stores in which the membership card is capable of being used; receiving the locations of the one or more affiliate stores from the affiliate store location information collection device; and providing the affiliate store location service to a user using the locations of the one or more affiliate stores.

Also, according to another aspect of the present invention, there is provided a computer program, stored in a medium, for implementing the above-mentioned methods.

Also, a system for collecting affiliate store location information according to the present invention includes: a terminal device for collecting usage log information corresponding to a membership card used through an application, for transmitting the usage log information to an affiliate store location information collection device to enable the affiliate store location information collection device to provide an affiliate store location service, and for providing the affiliate store location service to a user by receiving locations of one or more affiliate stores from the affiliate store location information collection device; and the affiliate store location information collection device, for receiving the usage log information about the membership card used through the application from the terminal device, for storing the usage log information in connection with an affiliate store in which the membership card was used, and for registering a location of the affiliate store in which the membership card was used in an affiliate store database depending on whether the usage log information has been collected so as to meet a predetermined registration condition, in order to provide the affiliate store location service to the terminal device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a system for collecting affiliate store location information according to an embodiment of the present invention;

FIG. 2 is a block diagram illustrating an example of the affiliate store location information collection device, illustrated in FIG. 1;

FIG. 3 is a block diagram illustrating an example of the terminal device, illustrated in FIG. 1;

FIG. 4 is a view illustrating the operation process of a Syrup server, which is an embodiment to which a method for collecting affiliate store location information according to the present invention is applied;

FIG. 5 is a flowchart in which a method for collecting affiliate store location information according to an embodiment of the present invention is described in terms of an affiliate store location information collection device;

FIG. 6 is a flowchart in which a method for collecting affiliate store location information according to an embodiment of the present invention is described in terms of a terminal device; and

FIG. 7 is a view in which a method for collecting affiliate store location information according to an embodiment of the present invention is described in detail.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. It should be noted that the same reference numerals are used to designate the same or similar elements throughout the drawings.

Terms or words used in this specification and claims should not be interpreted according to typical or dictionary meanings, but should be interpreted as having meanings and concepts adapted to the technical idea of the present invention based on the principle that an inventor may properly define the concept of the terms in order to explain the present invention in the best way. Therefore, embodiments disclosed in this specification and configurations illustrated in the drawings are merely preferred embodiments of the present invention and do not fully describe the technical idea of the present invention, and thus there may be various equivalents and alterations replacing them at the filing date of the present application. Also, it will be understood that, although the terms “first”, “second”, etc. may be used herein to describe various elements, these elements should not be limited by these terms. These terms are only used to distinguish one element from another.

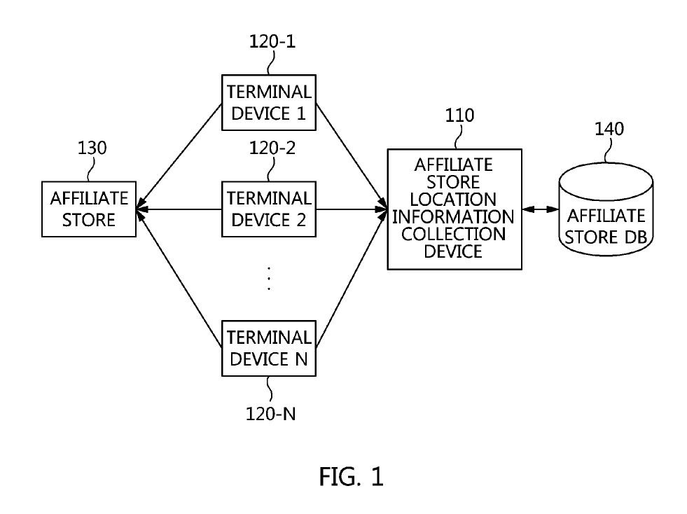

FIG. 1 is a block diagram illustrating a system for collecting affiliate store location information according to an embodiment of the present invention.

Referring to FIG. 1, a system for collecting affiliate store location information, according to an embodiment of the present invention, includes an affiliate store location information collection device 110, terminal devices 120-1 to 120-N, an affiliate store 130, and an affiliate store database 140.

The affiliate store location information collection device 110 receives usage log information about the use of a membership card, which was used through an application, from the terminal devices 120-1 to 120-N. In this case, the usage log information may correspond to at least one of card identification information corresponding to the membership card, information about the current locations of the terminal devices 120-1 to 120-N, and information about the Wi-Fi access point of the affiliate store 130 in which the membership card was used.

Also, the affiliate store location information collection device 110 stores the usage log information in connection with the affiliate store 130 in which the membership card was used. For example, using identification information such as an affiliate store ID included in the Wi-Fi access point information, the usage log information may be stored for each affiliate store.

Also, the affiliate store location information collection device 110 determines whether the collected usage log information meets a predetermined registration condition. Also, when the collected usage log information meets the predetermined registration condition, the affiliate store location information collection device 110 registers the location of the affiliate store 130 in which the membership card was used in the affiliate store database 140 to provide an affiliate store location service to the terminal devices 120-1 to 120-N. In this case, the predetermined registration condition may correspond to at least one of the case in which usage log information has been collected for a time period equal to or longer than a predetermined reference collection period and the case in which the number of collected pieces of usage log information is equal to or greater than a predetermined reference collection number. In this case, using the Wi-Fi access point information, one or more pieces of card identification information are retrieved for each affiliate store 130 in which the membership card was used, and the location of the affiliate store 130 corresponding to the one or more pieces of card identification information may be registered depending on whether, among the one or more pieces of card identification information, the number of identical pieces of card identification information that have been collected is equal to or greater than the predetermined collection number. In this case, the usage log information corresponding to the identical pieces of card identification information is registered in the affiliate store database 140, and the current location of the terminal devices 120-1 to 120-N, received along with the identical pieces of card identification information from the terminal devices 120-1 to 120-N, may be registered as the location of the affiliate store 130 in which the membership card was used. In this case, comparing membership points before and after the membership card was used, if the membership points before the membership card was used are identical to the membership points after the membership card was used, the location of the affiliate store in which the membership card was used may not be registered.

Also, the affiliate store location information collection device 110 searches the affiliate store database 140 for one or more affiliate stores 130 in which the membership card can be used based on the usage log information, and provides the locations of the found affiliate stores 130 to the terminal devices 120-1 to 120-N so as to provide the affiliate store location service. In this case, the affiliate store database 140 is searched for one or more pieces of Wi-Fi access point information corresponding to the card identification information, and the locations of the one or more affiliate stores 130 are provided using the current locations of the terminal devices 120-1 to 120-N corresponding to the one or more pieces of Wi-Fi access point information.

The terminal devices 120-1 to 120-N collect one or more pieces of usage log information among identification information for the membership card used through the application, the current location information, and information about the Wi-Fi access point of the affiliate store 130 in which the membership card was used. In this case, the usage log information may be collected using at least one of one or more types of sensors included in the terminal devices 120-1 to 120-N and the application.

Also, the terminal devices 120-1 to 120-N transmit the usage log information to the affiliate store location information collection device 110 to enable the affiliate store location information collection device 110 to provide the affiliate store location service, which shows the locations of one or more affiliate stores 130 in which the membership card can be used, based on the usage log information.

Also, the terminal devices 120-1 to 120-N provide the user with the affiliate store location service by receiving the locations of the one or more affiliate stores 130 from the affiliate store location information collection device 110. In this case, the locations of the one or more affiliate stores 130 may be displayed on a map.

Also, each of the terminal devices 120-1 to 120-N is a device capable of transmitting and receiving data with the affiliate store location information collection device 110 through an application by being connected to a network, and may be one of various terminals such as all data communication devices, multimedia terminals, wired terminals, and the like, without limitation to a mobile communication terminal. Each of the terminal devices 120-1 to 120-N may be a mobile terminal having various mobile communication forms, such as a cellular phone, a Portable Multimedia Player (PMP), a Mobile Internet Device (MID), a smart phone, a tablet PC, a notebook computer, a net book, a Personal Digital Assistant (PDA), a data communication device, etc.,

The affiliate store 130 may be a shop or store affiliated with the company corresponding to the membership card, and the place in which the membership card can be used through the application installed in the terminal devices 120-1 to 120-N. Also, the affiliate store 130 may have a Wi-Fi access point so that the terminal devices 120-1 to 120-N using the membership card may collect the Wi-Fi access point information corresponding to the relevant affiliate store 130. In this case, the Wi-Fi access point information may include the identification information about each affiliate store 130, an address, the strength of a signal, and the like.

The affiliate store database 140 may register and delete information about the locations of affiliate stores 130 in which the membership card can be used. For example, information about the location of a new affiliate store 130 is registered through the affiliate store location information collection device 110, whereby, when a user makes a request for information about an affiliate store in which a specific membership card can be used, the corresponding information may be provided.

Also, if the affiliate store location information collection device 110 has not collected usage log information corresponding to a specific affiliate store registered in the affiliate store database 140 for a certain period of time, the affiliate store database 140 may delete the registered information about the location of the affiliate store 130.

Also, because the affiliate store database 140 stores the usage log information, when it receives a request for the location of an affiliate store 130 corresponding to a specific membership card from a user, it may provide the location of the affiliate store 130 using the Wi-Fi access point information, stored with the card identification information, and using the current location of the terminal devices 120-1 to 120-N.

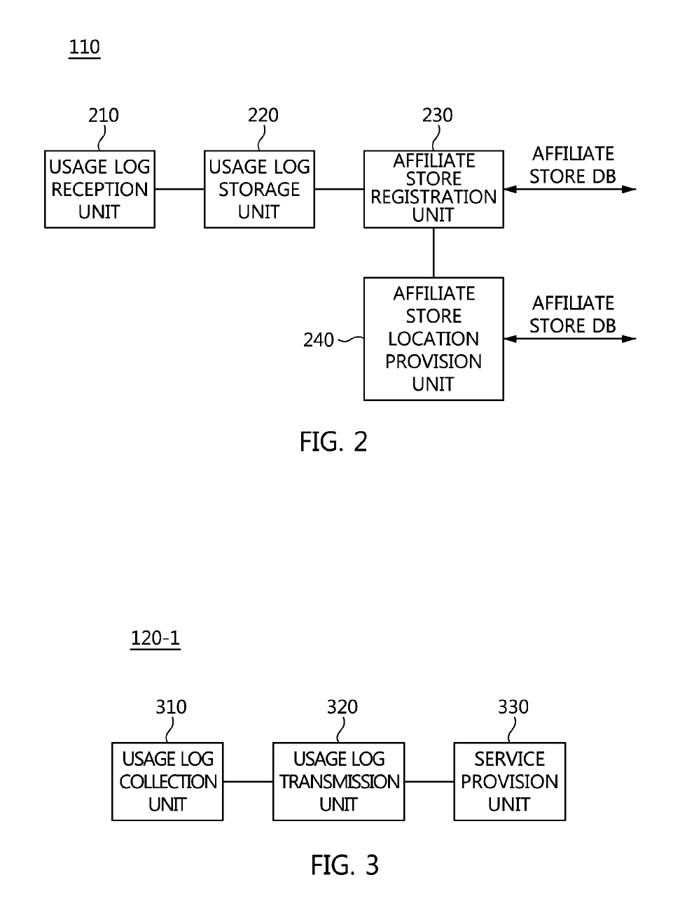

FIG. 2 is a block diagram illustrating an example of the affiliate store location information collection device illustrated in FIG. 1.

Referring to FIG. 2, the affiliate store location information collection device 110 illustrated in FIG. 1 includes a usage log reception unit 210, a usage log storage unit 220, an affiliate store registration unit 230, and an affiliate store location provision unit 240.

The usage log reception unit 210 receives usage log information about a membership card, used through an application, from a terminal device. For example, when a user having a terminal device enters an affiliate store in which a membership card can be used and uses the membership card, the usage log information may be collected through the terminal device and the collected usage log information may be received by the usage log reception unit.

In this case, the usage log information may correspond to at least one of card identification information corresponding to the membership card, information about the current location of the terminal device, and information about the Wi-Fi access point of the affiliate store in which the membership card was used. Here, the Wi-Fi access point information may include affiliate store identification information, the address of a relevant access point, the signal strength of the access point, and the like. Accordingly, the affiliate store may be identified through the Wi-Fi access point information.

The usage log storage unit 220 stores the usage log information in connection with the affiliate store in which a membership card was used. For example, the usage log information may be stored for each affiliate store based on the affiliate store information acquired through the Wi-Fi access point information.

The affiliation store registration unit 230 determines whether the collected usage log information meets a predetermined registration condition. When the collected usage log information meets the predetermined registration condition, the affiliate store registration unit registers the location of the affiliate store in which the membership card was used in the affiliate store database in order to provide an affiliate store location service to the terminal devices. For example, considering that the collected usage log information may contain an error, the registration condition is determined to collect a suitable amount of usage log information, rather than registering the affiliate store using only one or two pieces of usage log information, and when sufficient usage log information has been collected to meet the corresponding condition, the relevant affiliate store may be registered in the affiliate store database.

Here, the affiliate store database is a storage device capable of storing information about affiliate stores in which a membership card can be used, and may register the location of a new affiliate store and delete a registered affiliate store location. For example, the location of an affiliate store, confirmed through the affiliate store location information collection device 110, is registered, or a registered affiliate store in connection with which the usage log information has not been collected through the affiliate store location information collection device 110 for a certain period of time is deleted from the affiliate store database, whereby latest affiliate store information may be kept up to date.

In this case, the predetermined registration condition may correspond to at least one of the case in which the usage log information has been collected for a time period equal to or longer than a predetermined reference collection period and the case in which the number of collected pieces of usage log information is equal to or greater than a predetermined reference collection number. For example, considering that the collected usage log information may contain an error, the usage log information is collected for a time period ranging from a week to a month, and the location of the affiliate store may be registered based on the collected usage log information. Also, the number of times that usage log information is collected is set to 100, and when the number of collected pieces of usage log information for a specific affiliate store is equal to or greater than 100, the affiliate store may be registered.

In this case, using the Wi-Fi access point information, one or more pieces of card identification information are retrieved for each affiliate store, in which the membership card was used, and the location of the affiliate store corresponding to the one or more pieces of card identification information may be registered depending on whether, among the one or more pieces of card identification information, the number of identical pieces of card identification information that have been collected is equal to or greater than a predetermined collection number. For example, if the kinds of membership cards that can be used through the application installed in the terminal device are A, B, and C, and if the membership cards that can be used in an affiliate store D are A and B, the usage log information collected for the affiliate store D may correspond to any one of the identification information for the membership card A and the identification information for the membership card B. In this case, if the number of pieces of usage log information that must be collected to satisfy the registration condition is 50, when 100 pieces of usage log information and 30 pieces of usage log information are collected respectively for the membership card A and the membership card B, the affiliate store D may be registered as an affiliate store for the membership card A.

In this case, the usage log information corresponding to the identical pieces of card identification information is registered in the affiliate store database, and the current location of the terminal device, received along with the identical pieces of card identification information from the terminal device, may be registered as the location of the affiliate store in which the membership card was used. For example, when the membership card is used, because the user is located in the affiliate store, the current location of the terminal device may be the same as the location of the affiliate store. Therefore, the current location of the terminal device, received along with the card identification information, may be registered as the location of the affiliate store.

In this case, comparing membership points before and after the membership card was used, if the membership points before the membership card was used are identical to the membership points after the membership card was used, the location of the affiliate store in which the membership card was used may not be registered. For example, according to a criterion for sensing the use of the membership card by the terminal device, the membership card may be mistakenly understood to have been used in a place that is not an affiliate store. Therefore, to prevent such an error, the membership points associated with the relevant membership card are compared with the points after it is determined that the membership card was used, and if the membership points have not changed, it may be determined that the membership card erroneously sensed. Also, even if the usage log information, collected when the membership card was erroneously sensed, meets the condition for registering the affiliate store, the affiliate store is not registered and the usage log information may be deleted without being stored.

The affiliate store location provision unit 240 searches the affiliate store database for one or more affiliate stores in which the membership card can be used based on the usage log information, and provides the locations of the found affiliate stores to the terminal device so as to perform the affiliate store location service.

In this case, the affiliate store database is searched for one or more pieces of Wi-Fi access point information corresponding to the card identification information, and the locations of the one or more affiliate stores may be provided using the current location of the terminal device corresponding to the one or more pieces of Wi-Fi access point information. For example, the user of the terminal device executes the application, selects a membership card A through the application, and may request the location of an affiliate store in which the membership card A can be used. In this case, the usage log information corresponding to the identification information for the membership card A is retrieved from the affiliate store database, and as a result, the Wi-Fi access point information may be acquired. In this case, because the acquired Wi-Fi access point information corresponds to each of the affiliate stores, the location of the affiliate store in which the membership card A can be used may be acquired through the current location of the terminal device, stored with the Wi-Fi access point information, and may then be provided.

FIG. 3 is a block diagram illustrating an example of the terminal device illustrated in FIG. 1.

Referring to FIG. 3, the terminal device 120-1, illustrated in FIG. 1, includes a usage log collection unit 310, a usage log transmission unit 320, and a service provision unit 330.

The usage log collection unit 310 collects one or more pieces of usage log information among card identification information about a membership card used through an application, information about the current location, and information about the Wi-Fi access point of the affiliate store in which the membership card was used. For example, when a membership card is read by executing the application in an affiliate store, the use of the membership card may be detected. In this case, the location of the terminal device 120-1 at the moment at which the use of the membership card was detected may be acquired along with the card identification information about the relevant membership card, and the Wi-Fi access point information may be collected by acquiring the signal of the Wi-Fi access point installed in the relevant affiliate store.

In this case, the usage log information may be collected using at least one of one or more types of sensors, included in the terminal device 120-1, and the application. For example, the current location of the terminal device 120-1 may be acquired using a GPS sensor installed in the terminal device 120-1. Also, the signal of a Wi-Fi access point installed in the affiliate store may be received using a Wi-Fi sensor, whereby the Wi-Fi access point information may be collected. Also, the identification information about the membership card used in the affiliate store may be acquired using an application installed in the terminal device 120-1.

The usage log transmission unit 320 transmits the usage log information to the affiliate store location information collection device to enable the affiliate store location information collection device to provide an affiliate store location service, which shows the locations of one or more affiliate stores in which the membership card can be used based on the usage log information. In this case, through a wireless network, the data may be transmitted and received by the application installed in the terminal device 120-1.

The service provision unit 330 provides the affiliate store location service by receiving the locations of one or more affiliate stores from the affiliate store location information collection device.

In this case, the locations of the one or more affiliate stores may be displayed on a map. For example, the locations may be displayed on the map included in the application for using the membership card, or a map application installed in the terminal device 120-1 may be executed, and the locations of the affiliate stores may be marked on the map.

Also, the addresses of the affiliate stores may be provided as a list in which the addresses are arranged in ascending order of distance from the terminal device of the current user.

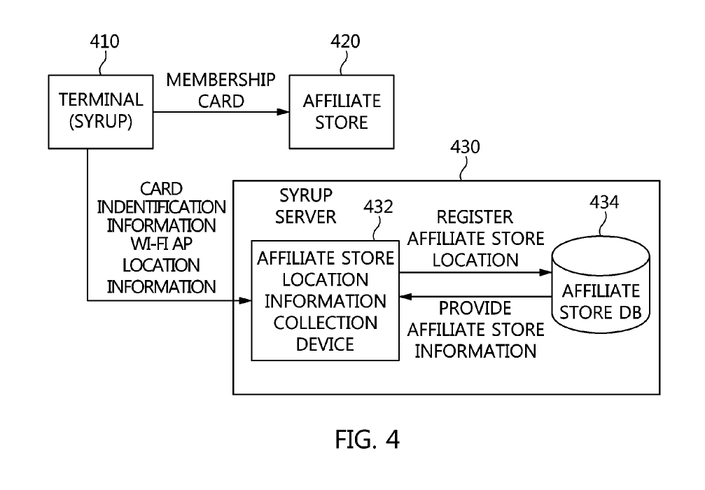

FIG. 4 is a view illustrating the operation process of a Syrup server, which is an embodiment to which a method for collecting affiliate store location information according to the present invention is applied.

Referring to FIG. 4, a Syrup application for using a membership card that can be used in the affiliate store 420 is installed in the terminal device 410.

In this case, the user of the terminal device 410 may use the membership card by executing the Syrup application in the affiliate store 420. In this case, the terminal device 410 may acquire the current location of the terminal device 410 using the GPS sensor included in the terminal device 410. Also, the terminal device 410 receives the signal of an access point installed in the affiliate store 420 using the Wi-Fi sensor included in the terminal device 410, and may acquire Wi-Fi access point information through the received signal. Also, the terminal device 410 may collect identification information for the membership card, which was used in the affiliate store 420, through the Syrup application.

Then, the terminal device 410 may transmit the usage log information, which corresponds to the card identification information, the Wi-Fi access point information, and the current location information, to the affiliate store location information collection device 432 of the Syrup server 430.

Subsequently, the affiliate store location information collection device 432 determines whether the usage log information, collected for the affiliate store 420, meets a predetermined registration condition, and may register the location of the affiliate store 420 in the affiliate store database 434 when the usage log information meets the predetermined registration condition.

Subsequently, the user of the terminal device 410 may execute the Syrup application and request information about affiliate stores in which a specific membership card can be used from the Syrup server 430. In this case, the Syrup server 430 searches the affiliate store database 434 for information about relevant affiliate stores, and may provide the information to the terminal device 410 via the affiliate store location information collection device 432.

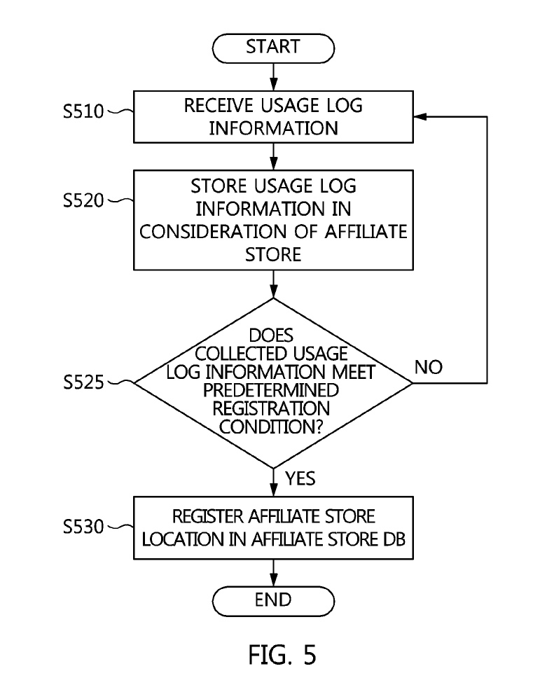

FIG. 5 is a flowchart in which a method for collecting affiliate store location information according to an embodiment of the present invention is described in terms of an affiliate store location information collection device.

Referring to FIG. 5, a method for collecting affiliate store location information according to an embodiment of the present invention receives usage log information about a membership card, used through an application, from a terminal device at step S510. For example, when a user having a terminal device enters an affiliate store in which a membership card can be used and uses the membership card, the usage log information may be collected through the terminal device, and the collected usage log information may be received.

In this case, the usage log information may correspond to at least one of card identification information corresponding to the membership card, information about the current location of the terminal device, and information about the Wi-Fi access point of the affiliate store in which the membership card was used. Here, the Wi-Fi access point information may include affiliate store identification information, the address of a relevant access point, the signal strength of the access point, and the like. Accordingly, the affiliate store may be identified through the Wi-Fi access point information.

Also, the method for collecting affiliate store location information according to an embodiment of the present invention stores the usage log information in connection with the affiliate store in which a membership card was used at step S520. For example, the usage log information may be stored for each affiliate store based on the affiliate store information acquired through the Wi-Fi access point information.

Also, the method for collecting affiliate store location information according to an embodiment of the present invention determines whether the collected usage log information meets a predetermined registration condition at step S525.

In this case, the predetermined registration condition may correspond to at least one of the case in which the usage log information has been collected for a time period equal to or longer than a predetermined reference collection period and the case in which the number of collected pieces of usage log information is equal to or greater than a predetermined reference collection number. For example, considering that the collected usage log information may contain an error, the usage log information is collected for a time period ranging from a week to a month, and the location of the affiliate store may be registered based on the collected usage log information. Also, the number of usage logs that must be collected is set to 100, and when the number of collected pieces of usage log information for a specific affiliate store is equal to or greater than 100, the affiliate store may be registered.

As a result of the determination at step S525, if the collected usage log information does not meet the predetermined registration condition, the location of the affiliate store is not registered, and more usage log information may be collected.

As a result of the determination at step S525, if the collected usage log information meets the predetermined registration condition, the method for collecting affiliate store location information according to an embodiment of the present invention registers the location of the affiliate store in which the membership card was used in the affiliate store database in order to provide an affiliate store location service to the terminal device at step S530. For example, considering that the collected usage log information may contain an error, the registration condition is determined such that a sufficient amount of usage log information is collected, rather than registering the affiliate store using only one or two pieces of usage log information, and when the collected usage log information meets the corresponding condition, the relevant affiliate store may be registered in the affiliate store database.

In this case, the affiliate store database is a storage device capable of storing information about affiliate stores in which a membership card can be used, and may register the location of a new affiliate store and delete the registered affiliate store location. For example, the location of an affiliate store, confirmed through the affiliate store location information collection device, is registered, or a registered affiliate store for which usage log information has not been collected through the affiliate store location information collection device for a certain period of time is deleted from the affiliate store database, whereby the affiliate store information may be kept up to date.

In this case, using the Wi-Fi access point information, one or more pieces of card identification information are retrieved for each affiliate store, in which the membership card was used. Also, the location of the affiliate store corresponding to the one or more pieces of card identification information may be registered depending on whether, among the one or more pieces of card identification information, the number of identical pieces of card identification information that have been collected is equal to or greater than a predetermined collection number. For example, if the kinds of membership cards that can be used through the application installed in the terminal device are A, B, and C, and if the kinds of membership card that can be used in an affiliate store D are A and B, the usage log information collected for the affiliate store D may correspond to any one of the identification information for the membership card A and the identification information for the membership card B. In this case, if the number of pieces of usage log information to be collected, set as a registration condition, is 50, when 100 pieces of usage log information and 30 pieces of usage log information are collected respectively for membership card A and membership card B, the affiliate store D may be registered as an affiliate store for membership card A.

In this case, the usage log information corresponding to the identical pieces of card identification information is registered in the affiliate store database. Also, the current location of the terminal device, which was received along with the identical pieces of card identification information from the terminal device, may be registered as the location of the affiliate store in which the membership card was used. For example, when the membership card is used, because the user is located in the affiliate store, the current location of the terminal device may be identical to the location of the affiliate store. Therefore, the current location of the terminal device, received along with the card identification information, may be registered as the location of the affiliate store.

In this case, comparing the membership points before and after the membership card was used, if the membership points before the membership card was used are identical to the membership points after the membership card was used, the location of the affiliate store in which the membership card was used may not be registered. For example, according to a criterion for sensing the use of the membership card by the terminal device, it may be mistakenly understood that the membership card was used in a place that is not an affiliate store. Therefore, to prevent such an error, the membership points of the relevant membership card are compared with the points after it is determined that the membership card was used, and if the membership points have not changed, it may be determined that the membership card was erroneously sensed. Also, even if the usage log information, collected when the membership card was erroneously sensed, meets the condition for registering the affiliate store, the affiliate store is not registered, and the usage log information may be deleted without being stored.

Also, although not illustrated in FIG. 5, the method for collecting affiliate store location information according to an embodiment of the present invention searches the affiliate store database for one or more affiliate stores in which the membership card can be used, based on the usage log information, and provides the locations of the found affiliate stores to the terminal device so as to perform the affiliate store location service.

In this case, the affiliate store database is searched for one or more pieces of Wi-Fi access point information corresponding to the card identification information, and the locations of the one or more affiliate stores may be provided using the current location of the terminal device corresponding to the one or more pieces of Wi-Fi access point information. For example, the user of the terminal device executes the application, selects a membership card A through the application, and may request the location of an affiliate store in which the membership card A can be used. In this case, the usage log information corresponding to the identification information for the membership card A is retrieved from the affiliate store database, and as a result, the Wi-Fi access point information may be acquired. In this case, because the acquired Wi-Fi access point information corresponds to each of the affiliate stores, the location of the affiliate store in which the membership card A can be used may be acquired through the current location of the terminal device, which is stored with the Wi-Fi access point information, and may then be provided.

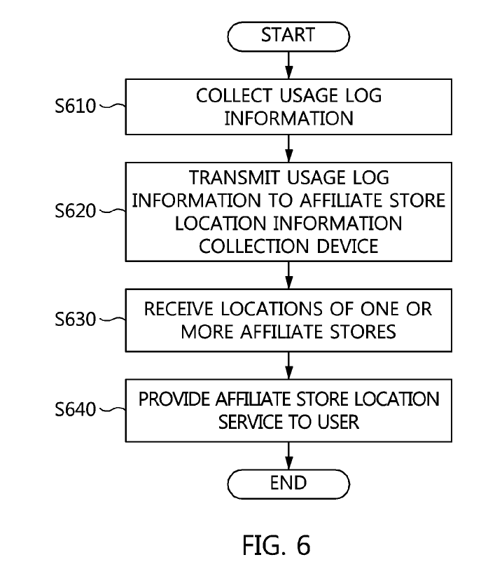

FIG. 6 is a flowchart in which a method for collecting affiliate store location information according to an embodiment of the present invention is described in terms of a terminal device.

Referring to FIG. 6, a method for collecting affiliate store location information according to an embodiment of the present invention collects one or more pieces of usage log information among card identification information about a membership card used through an application, information about the current location, and information about the Wi-Fi access point of the affiliate store in which the membership card was used at step S610. For example, when a membership card is read by executing the application in an affiliate store, the use of the membership card may be detected. In this case, the location of the terminal device 120-1 at the moment at which the use of the membership card is detected may be acquired along with the identification information for the relevant membership card, and the Wi-Fi access point information may be collected by acquiring the signal of the Wi-Fi access point installed in the relevant affiliate store.

In this case, the usage log information may be collected using at least one of one or more types of sensors, included in the terminal device, and the application. For example, the current location of the terminal device may be acquired using a GPS sensor installed in the terminal device. Also, the signal of a Wi-Fi access point installed in the affiliate store may be received using a Wi-Fi sensor, whereby the Wi-Fi access point information may be collected. Also, the identification information about the membership card used in the affiliate store may be acquired using an application installed in the terminal device.

Also, the method for collecting affiliate store location information according to an embodiment of the present invention transmits the usage log information to the affiliate store location information collection device to enable the affiliate store location information collection device to provide an affiliate store location service, which shows the locations of one or more affiliate stores in which the membership card can be used based on the usage log information at step S620. In this case, through a wireless network, the data may be transmitted and received by the application installed in the terminal device.

Also, the method for collecting affiliate store location information according to an embodiment of the present invention receives the locations of one or more affiliate stores from the affiliate store location information collection device at step S630.

Also, the method for collecting affiliate store location information according to an embodiment of the present invention provides a user with an affiliate store location service using the locations of the one or more affiliate stores at step S640.

In this case, the locations of the one or more affiliate stores may be displayed on a map. For example, the locations may be displayed on the map included in the application for using the membership card, or a map application installed in the terminal device 120-1 may be executed, and the locations of the affiliate stores may be marked on the map.

Also, the addresses of the affiliate stores may be provided as a list in which the addresses are arranged in ascending order of distance from the terminal device of the current user.

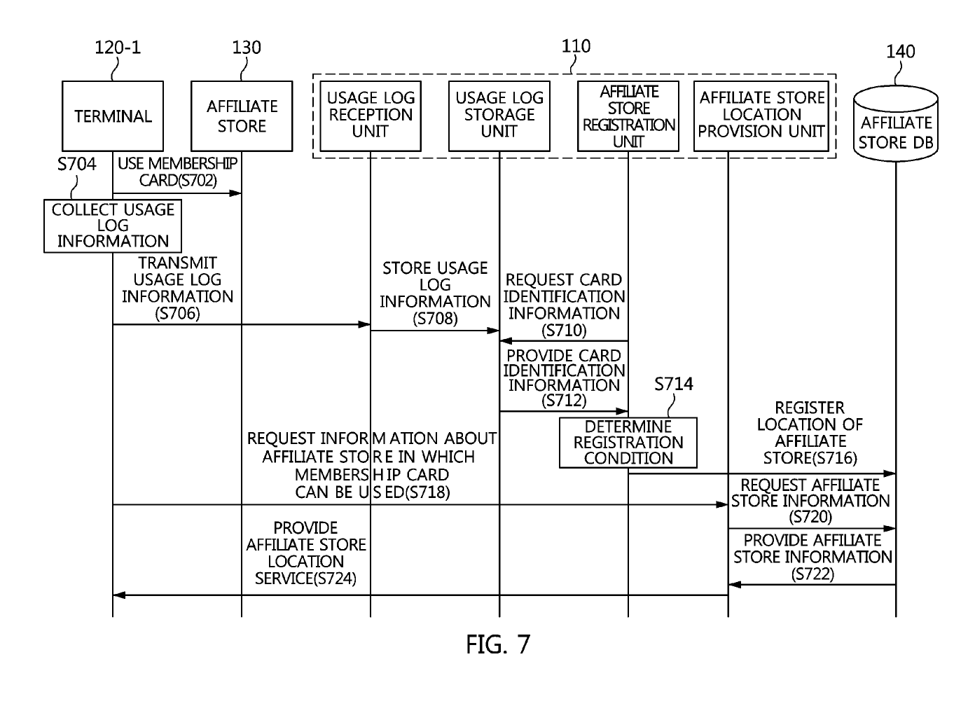

FIG. 7 is a view in which a method for collecting affiliate store location information according to an embodiment of the present invention is described in detail.

Referring to FIG. 7, in a method for collecting affiliate store location information according to an embodiment of the present invention, the terminal device 120-1 uses a membership card using an application in an affiliate store 130 at step S702.

Also, the method for collecting affiliate store location information according to an embodiment of the present invention collects usage log information corresponding to the membership card used by the terminal device 120-1 at step S704. In this case, the usage log information may correspond to at least one of card identification information corresponding to the membership card, information about the current location of the terminal device 120-1, and information about the Wi-Fi access point of the affiliate store 130.

Also, the method for collecting affiliate store location information according to an embodiment of the present invention transmits the usage log information, collected by the terminal device 120-1, to the usage log reception unit of an affiliate store location information collection device 110 at step S706.

Also, in the method for collecting affiliate store location information according to an embodiment of the present invention, the usage log storage unit of the affiliate store location information collection device 110 stores the received usage log information in connection with the affiliate store at step S708.

Also, in the method for collecting affiliate store location information according to an embodiment of the present invention, when the affiliate store registration unit of the affiliate store location information collection device 110 requests card identification information for an affiliate store from the usage log storage unit at step S710, the usage log storage unit provides the card identification information to the affiliate store registration unit at step S712. In this case, the usage log storage unit may provide the affiliate store registration unit with card identification information, which is separately stored according to the affiliate store using the Wi-Fi access point information.

Also, in the method for collecting affiliate store location information according to an embodiment of the present invention, the affiliate store registration unit determines whether the identification information for the membership card, that is, the collected usage log information, meets a predetermined registration condition at step S714.

Also, in the method for collecting affiliate store location information according to an embodiment of the present invention, if the collected usage log information does not meet the predetermined registration condition, the registration may be deferred until more usage log information for the relevant affiliate store is collected.

Also, in the method for collecting affiliate store location information according to an embodiment of the present invention, if the collected usage log information meets the predetermined registration condition, the location of the affiliate store corresponding to the usage log information is registered in an affiliate store database 140 at step S716. In this case, the location of the affiliate store may be registered to correspond to information about the current location of the terminal device, included in the usage log information.

Also, in the method for collecting affiliate store location information according to an embodiment of the present invention, the terminal device 120-1 requests information about affiliate stores in which the membership card can be used from the affiliate store location provision unit of the affiliate store location information collection device 110 at step S718.

Also, in the method for collecting affiliate store location information according to an embodiment of the present invention, the affiliate store location provision unit requests the affiliate store information corresponding to the identification information for the membership card, requested by the terminal device 120-1, from the affiliate store database 140 at step S720.

Also, in the method for collecting affiliate store location information according to an embodiment of the present invention, the affiliate store database 140 provides the affiliate store location provision unit with information about the location of the affiliate store, in which the membership card can be used, requested by the user, at step S722.

Also, in the method for collecting affiliate store location information according to an embodiment of the present invention, the affiliate store location provision unit provides the terminal device 120-1 with the location of affiliate stores in which the membership card can be used so as to provide the affiliate store location service at step S724. In this case, the terminal device 120-1 may provide the user with the received affiliate store location by displaying it thereon.

The method for collecting affiliate store location information according to the present invention may be implemented as a program that can be executed by various computer means. In this case, the program may be recorded on a computer-readable storage medium. The computer-readable storage medium may include program instructions, data files, and data structures, either solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as a CD-ROM and a DVD, magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

According to the present invention, because the locations of affiliate stores are acquired by collecting information about the use of membership cards used by users in the real world, reliable information about the location of the affiliate stores may be provided to the users.

Also, the present invention may save manpower, time, and cost required for collecting information about the locations of affiliate stores.

As described above, a system for collecting affiliate store location information using information about the use of membership cards, a method for collecting affiliate store location information, and a device for the method are not limitedly applied to the configurations and operations of the above-described embodiments, but all or some of the embodiments may be selectively combined and configured, so that the embodiments may be modified in various ways.

According to the present invention, usage log information about the use of a membership card, which was used through an application, is received from a terminal device, the usage log information is stored in connection with an affiliate store, and whether the collected usage log information meets a predetermined registration condition is determined. If the collected usage log information meets the predetermined registration condition, the location of the affiliate store in which the membership card was used may be registered in an affiliate store database to provide an affiliate store location service to the terminal device. Furthermore, because manpower, time, and resources required for collecting information about the locations of affiliate stores may be saved, overall resources for providing the affiliate store location service to users may be effectively managed.

What is claimed is:

1. A device for collecting affiliate store location information, comprising:
a usage log reception unit for receiving usage log information about a membership card, used through an application, from a terminal device;
a usage log storage unit for storing the usage log information in connection with an affiliate store in which the membership card was used; and
an affiliate store registration unit for determining whether the usage log information has been collected so as to meet a predetermined registration condition, and for registering a location of the affiliate store in which the membership card was used in an affiliate store database to provide an affiliate store location service to the terminal device when the usage log information has been collected so as to meet the predetermined registration condition.

2. The device of claim 1, wherein the predetermined registration condition corresponds to at least one of a case in which the usage log information has been collected for a time period equal to or longer than a predetermined reference collection period and a case in which a number of the collected pieces of usage log information is equal to or greater than a predetermined reference collection number.

3. The device of claim 2, wherein the usage log information corresponds to at least one of card identification information corresponding to the membership card, information about a current location of the terminal device, and information about a Wi-Fi access point of the affiliate store in which the membership card was used.

4. The device of claim 3, wherein the affiliate store registration unit is configured to:
search for one or more pieces of card identification information for each affiliate store in which the membership card was used using the information about the Wi-Fi access point, and
register a location of the affiliate store corresponding to the one or more pieces of card identification information depending on a determination of whether, among the one or more pieces of card identification information, a number of identical pieces of card identification information that have been collected is equal to or greater than the predetermined reference collection number.

5. The device of claim 4, wherein the affiliate store registration unit stores the usage log information corresponding to the identical pieces of card identification information in the affiliate store database, and registers the information about the current location of the terminal device, received along with the identical pieces of card identification information from the terminal device, as the location of the affiliate store in which the membership card was used.

6. The device of claim 4, further comprising,
an affiliation store location provision unit for searching the affiliate store database for one or more affiliate stores in which the membership card is capable of being used based on the usage log information, and for performing the affiliate store location service by providing locations of the found one or more affiliate stores to the terminal device.

7. The device of claim 6, wherein the affiliate store location provision unit searches the affiliate store database for one or more pieces of Wi-Fi access point information corresponding to the card identification information, and provides the locations of the one or more affiliate stores using information about a current location of the terminal device corresponding to the one or more pieces of Wi-Fi access point information.

8. The device of claim 1, wherein the affiliate store registration unit compares membership points before the membership card was used with membership points after the membership card was used, and does not register a location of the affiliate store in which the membership card was used if the membership points before the membership card was used are identical to the membership points after the membership card was used.

9. A terminal device, comprising:
a usage log collection unit for collecting usage log information about one or more of card identification information about a membership card used through an application, current location information, and information about a Wi-Fi access point of an affiliate store in which the membership card was used;
a usage log transmission unit for transmitting the usage log information to an affiliate store location information collection device to enable the affiliate store location information collection device to provide an affiliate store location service for showing, based on the usage log information, locations of one or more affiliate stores in which the membership card is capable of being used; and
a service provision unit for providing the affiliate store location service to a user by receiving the locations of the one or more affiliate stores from the affiliate store location information collection device.

10. The terminal device of claim 9, wherein the usage log collection unit collects the usage log information using at least one of the application and one or more types of sensors included in the terminal device.

11. The terminal device of claim 9, wherein the service provision unit displays the locations of the one or more affiliate stores on a map.

12. A method for collecting affiliate store location information using information about use of a membership card, comprising:
receiving usage log information about the membership card, used through an application, from a terminal device;
storing the usage log information in connection with an affiliate store in which the membership card was used;
determining whether the usage log information has been collected so as to meet a predetermined registration condition; and
registering a location of the affiliate store in which the membership card was used in an affiliate store database to provide an affiliate store location service to the terminal device when the usage log information has been collected so as to meet the predetermined registration condition.

13. The method of claim 12, wherein the predetermined registration condition corresponds to at least one of a case in which the usage log information has been collected for a time period equal to or longer than a predetermined reference collection period and a case in which a number of the collected pieces of usage log information is equal to or greater than a predetermined reference collection number.

14. The method of claim 13, wherein the usage log information corresponds to at least one of card identification information corresponding to the membership card, information about a current location of the terminal device, and information about a Wi-Fi access point of the affiliate store in which the membership card was used.

15. The method of claim 14, wherein registering the location of the affiliate store comprises searching for one or more pieces of card identification information for each affiliate store in which the membership card was used using the information about the Wi-Fi access point, and
a location of the affiliate store corresponding to the one or more pieces of card identification information is registered depending on a determination of whether, among the one or more pieces of card identification information, a number of identical pieces of card identification information that have been collected is equal to or greater than the predetermined reference collection number.

16. The method of claim 15, wherein registering the location of the affiliate store further comprises storing the usage log information corresponding to the identical pieces of card identification information in the affiliate store database, and
the information about the current location of the terminal device, received along with the identical pieces of card identification information from the terminal device, is registered as the location of the affiliate store in which the membership card was used.

17. The method of claim 15, further comprising,
searching the affiliate store database for one or more affiliate stores in which the membership card is capable of being used based on the usage log information, and performing the affiliate store location service by providing locations of the found one or more affiliate stores to the terminal device.
